(19) United States
(12) Patent Application Publication
(10) Pub. No.: US 2025/0299639 A1
(43) Pub. Date: Sep. 25, 2025

(54) Data transmission method and related display driver circuit and host device

(71) Applicant: NOVATEK Microelectronics Corp., Hsin-Chu (TW)

(72) Inventors: Wei-Lun Shih, Hsinchu City (TW); Wen-Kai Hsieh, Hsinchu County (TW); Yen-Cheng Tsai, Hsinchu City (TW); Huan-Teng Cheng, Hsinchu City (TW); Kai-Wen Shao, Hsinchu City (TW)

(73) Assignee: NOVATEK Microelectronics Corp., Hsin-Chu (TW)

(21) Appl. No.: 19/078,246

(22) Filed: Mar. 12, 2025

Related U.S. Application Data
(60) Provisional application No. 63/568,433, filed on Mar. 21, 2024.

(30) Foreign Application Priority Data
Feb. 17, 2025 (TW) 114105710

(51) Int. Cl. G09G 3/3291

(52) U.S. Cl. CPC G09G 3/3291; G09G 2370/08

(57) ABSTRACT

A data transmission method for a display driver circuit includes steps of: receiving at least one first synchronization signal to determine a frame period for a plurality of image data in an image frame; when a first image data to be refreshed among the plurality of image data, receiving the first image data in a first transmission period corresponding to the first image data; and when a second image data not refreshed among the plurality of image data, stopping receiving the second image data in a second transmission period corresponding to the second image data.

### CROSS REFERENCE TO RELATED APPLICATIONS

This application claims the benefit of U.S. Provisional Application No. 63/568,433, filed on Mar. 21, 2024. The content of the application is incorporated herein by reference.

### BACKGROUND OF THE INVENTION

### 1. Field of the Invention

The present invention relates to a data transmission method for a display driver circuit and a host device, and more particularly, to a data transmission method for partial refresh of display data between a display driver circuit and a host device.

### 2. Description of the Prior Art

In recent years, the display data of most display devices are transmitted using the mobile industry processor interface (MIPI). The current MIPI specifications include the video mode and command mode. In the command mode, the display device is usually equipped with a frame buffer, and the display data transmitted through the MIPI may be written into the frame buffer. The corresponding display data are then retrieved from the frame buffer when the display device needs to refresh the image. In the video mode, the display device does not use a frame buffer. Instead, when the image needs to be refreshed, the host side transmits display data through the MIPI to refresh directly.

### SUMMARY OF THE INVENTION

It is therefore an objective of the present invention to provide a data transmission method for partial refresh of display data between the display driver circuit and the host device.

An embodiment of the present invention discloses a data transmission method. The data transmission method is used for a display driver circuit and comprises steps of: receiving at least one first synchronization signal to determine a frame period for a plurality of image data in an image frame; when a first image data to be refreshed among the plurality of image data, receiving the first image data in a first transmission period corresponding to the first image data; and when a second image data not refreshed among the plurality of image data, stopping receiving the second image data in a second transmission period corresponding to the second image data.

Another embodiment of the present invention discloses a data transmission method. The data transmission method is used for a host device and comprises steps of: outputting at least one first synchronization signal to determine a frame period for a plurality of image data in a first image frame; when a first image data to be refreshed among the plurality of image data, transmitting the first image data in a first transmission period corresponding to the first image data; and when a second image data not refreshed among the plurality of image data, stopping transmitting the second image data in a second transmission period corresponding to the second image data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display system according to an embodiment of the present invention.

FIG. 2 is a schematic diagram of the display panel in the display system performing image refresh operation.

FIG. 3 is a timing diagram of a transmission interface through which the host device transmits image data to the display driver circuit to allow the display panel to perform image refresh under a general video mode.

FIG. 4 is a timing diagram of a transmission interface through which the host device transmits partial image data to the display driver circuit to allow the display panel to perform image refresh according to an embodiment of the present invention.

FIG. 5 is a schematic diagram of the display panel in the display system performing partial refresh of image according to an embodiment of the present invention.

FIG. 6 illustrates the data transmission and refreshing method in the display system when the image does not change according to an embodiment of the present invention.

FIG. 7 is a timing diagram of the signals and data transmitted between the host device and the display driver circuit based on the data transmission method of FIG. 6.

FIG. 8 illustrates the data transmission and refreshing method in the display system according to another embodiment of the present invention.

FIG. 9 is a timing diagram of the signals and data transmitted between the host device and the display driver circuit based on the data transmission method of FIG. 8.

FIG. 10 illustrates the data transmission and refreshing method in the display system according to a further embodiment of the present invention.

FIG. 11 is a timing diagram of the signals and data transmitted between the host device and the display driver circuit based on the data transmission method of FIG. 10.

FIG. 12 illustrates the data transmission and refreshing method in the display system according to an additional embodiment of the present invention.

FIG. 13 is a timing diagram of the signals and data transmitted between the host device and the display driver circuit based on the data transmission method of FIG. 12.

FIG. 14 illustrates a data transmission method incorporating the refresh of X-direction partition according to an embodiment of the present invention.

FIG. 15 illustrates another data transmission method incorporating the refresh of X-direction partition according to an embodiment of the present invention.

FIG. 16 is a flowchart of a data transmission process according to an embodiment of the present invention.

FIG. 17 is a flowchart of another data transmission process according to an embodiment of the present invention.

### DETAILED DESCRIPTION

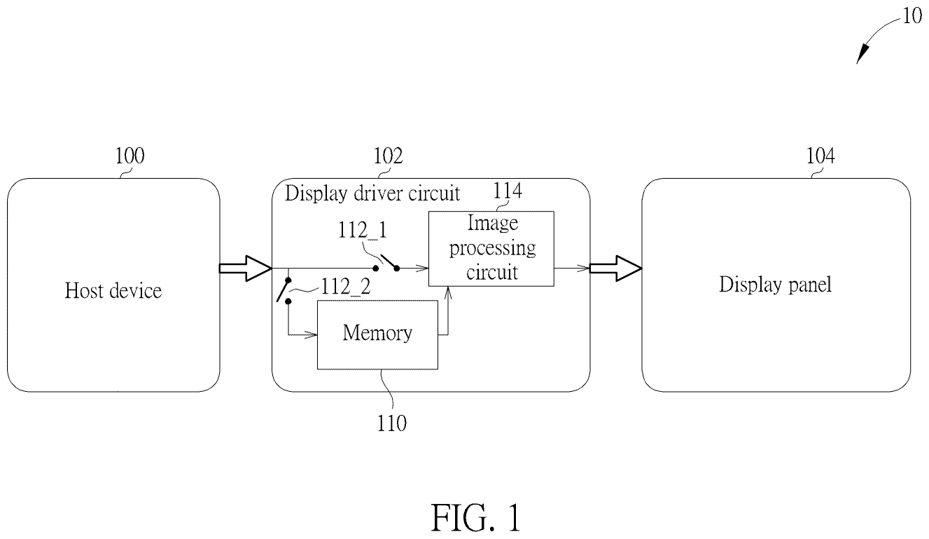

FIG. 1 is a schematic diagram of a display system 10 according to an embodiment of the present invention. The display system 10 includes a host device 100, a display driver circuit 102 and a display panel 104. The host device 100 may serve as a video source or video providing unit for outputting image data to the display driver circuit 102 to be displayed on the display panel 104. The display driver circuit 102 is configured to process the image data and convert the image data into corresponding data voltages to be output to the pixels on the display panel 104. Correspondingly, the display driver circuit 102 may also output control signals to the display panel 104, to control each pixel to be sequentially turned on to receive the data voltage. In various embodiments, the host device 100 may be, for example, an application processor (AP), central processing unit (CPU), microprocessor, microcontroller unit (MCU), or any other type of system processing device. In various embodiments, the display driver circuit 102 may be implemented in an integrated circuit (IC) to realize a display driver IC (DDIC). In various embodiments, the display panel 104 may be any type of display device, such as a light-emitting diode (LED) panel, organic LED (OLED) panel, or liquid crystal display (LCD) panel, but not limited thereto.

The display driver circuit 102 includes a memory 110, switches 112_1 and 112_2, and an image processing circuit 114. The memory 110 may be, for example, a static random access memory (SRAM) or graphic RAM (GRAM), and may serve as a frame buffer for storing the display data from the host device 100. The image processing circuit 114 is configured to perform various image processing operations on the display data to enhance the visual effect. These image processing operations include subpixel rendering and demura, but not limited thereto. In addition, the host device 100 may transmit display data to the display driver circuit 102 through the mobile industry processor interface As above, (MIPI). mentioned the MIPI specifications include the video mode and the command mode. Therefore, the display driver circuit 102 may control the switches 112_1 and 112_2 according to the operation mode of MIPI; hence, under different operation modes, the display driver circuit 102 may directly output the display data from the host device 100 to the display panel 104 (e.g., in the video mode), or write the display data into the memory 110 to be stored, and then output the display data to the display panel 104 from the memory 110 (e.g., in the command mode).

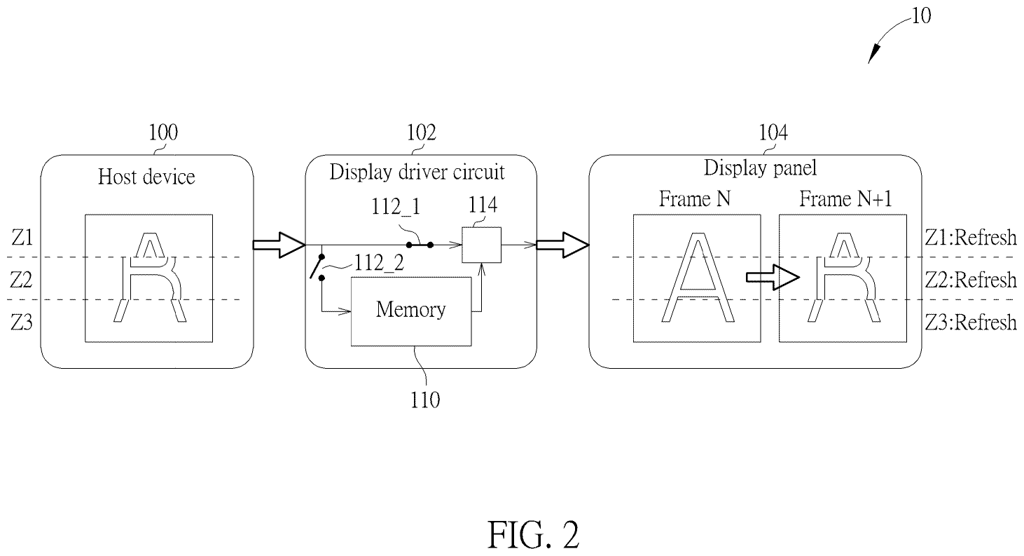

FIG. 2 is a schematic diagram of the display panel 104 in the display system 10 performing image refresh operation. In detail, the active area of the display panel 104 may be divided into three zones Z1-Z3, which shows a letter “A” in the current image frame N. In the next image frame (N+1), only the image content in the zone Z2 changes, while the images in the other zones Z1 and Z3 keep unchanged. During the first interval, the host device 100 transmits the data of frame N to the display driver circuit 102. If the host device 100 knows that in the next frame's data, only the specific zone Z2 needs to be updated, the host device 100 will first send the position information of zone Z2 to the display driver circuit 102. In other words, within the first interval, the host device 100 transmits the image data of frame N as well as the position information of zone Z2. Then, during the second interval, the host device 100 transmits only the image data of zone Z2 to the display driver circuit 102. In one embodiment, the position information is stored in two registers in the display driver circuit 102. The registers store a start address and an end address of the image to be refreshed. In another embodiment, the registers store line numbers corresponding to the image to be refreshed.

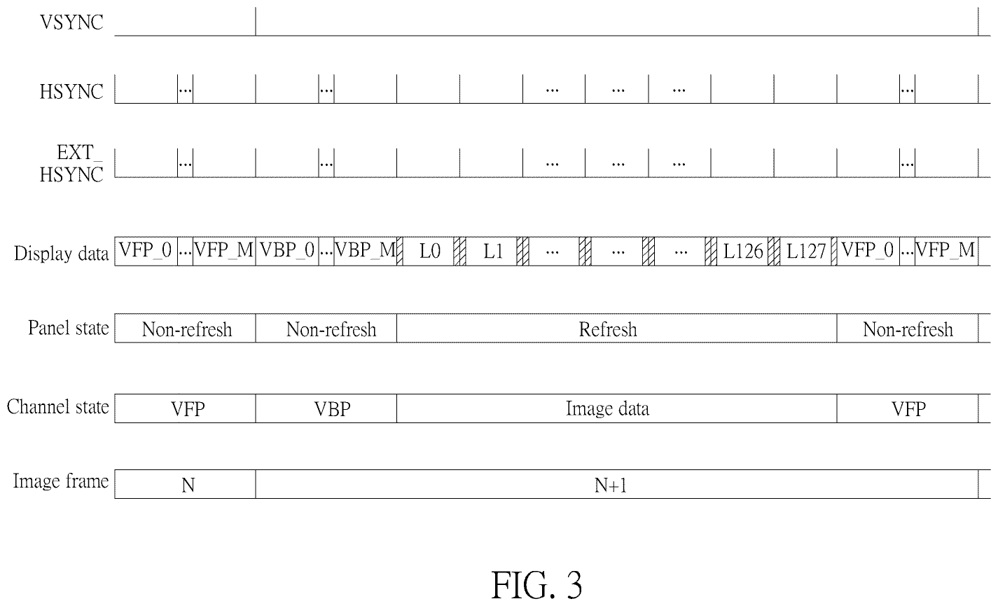

FIG. 3 is a timing diagram of a transmission interface through which the host device 100 transmits image data to the display driver circuit 102 to allow the display panel 104 to perform image refresh under a general video mode. In detail, FIG. 3 illustrates the data/signals forwarded through the transmission interface between the host device 100 and the display driver circuit 102, including a vertical synchronization signal VSYNC, a horizontal synchronization signal HSYNC and display data. To facilitate the illustrations, FIG. 3 also shows an external horizontal synchronization signal EXT_HSYNC which may be additionally received by the display driver circuit 102, and shows the state of the display panel 104 and the channel state of the transmission interface (e.g., MIPI).

The display driver circuit 102 may use the vertical synchronization signal VSYNC, the horizontal synchronization signal HSYNC and the external horizontal synchronization signal EXT_HSYNC to determine the timing of the display driver circuit 102 processing the display data, wherein the vertical synchronization signal VSYNC and the horizontal synchronization signal HSYNC may be provided to the display driver circuit 102 from the host device 100, and the external horizontal synchronization signal EXT_HSYNC may be received from an external device by the display driver circuit 102. In detail, the vertical synchronization signal VSYNC is used to determine a frame period for a frame of image (e.g., the image frames N, N+1 . . . etc.). The horizontal synchronization signal HSYNC and the external horizontal synchronization signal EXT_HSYNC are used to determine a display time for a row of image data. The display driver circuit 102 may optionally receive at least one of the horizontal synchronization signal HSYNC and the external horizontal synchronization signal EXT_HSYNC, to perform timing synchronization control for each row.

As shown in FIG. 3, a frame period determined by the vertical synchronization signal VSYNC may include a data transmission period, vertical front porches (VFP) VFP_0-VFP_M and vertical back porches (VBP) VBP_0-VBP_M. The vertical back porches VBP_0-VBP_M are the time period from a pulse of the vertical synchronization signal VSYNC until the start of transmission of active image data, and the vertical front porches VFP_0-VFP_M are the time period from the end of transmission of active image data to a pulse of the next vertical synchronization signal VSYNC. The data transmission period is a period for transmitting the active image data. Assuming that there are 128 rows of pixels on the display panel 104, according to the horizontal synchronization signal HSYNC (or the external horizontal synchronization signal EXT_HSYNC), the data transmission period may include 128 line time, in which the line image data (abbreviated as line data hereinafter) L0-L127 for each row of pixel are transmitted, respectively. Further, each line time not only includes the time period for transmitting each line data L0-L127, but also includes a horizontal front porch (HFP) and a horizontal back porch (HBP), which are omitted in FIG. 3 for brevity.

Referring to FIG. 3 along with FIG. 2, as mentioned above, in a general video mode, the host device 100 is requested to transmit the image data of an entire frame; hence, the host device 100 needs to transmit all line data L0-L127 in an image frame (e.g., N+1) to the display driver circuit 102 during the data transmission period. Correspondingly, the display driver circuit 102 may control the display panel 104 to refresh all images in the frame, which means that all of the zones Z1-23 are refreshed regardless of whether the image content changes.

In such a situation, during the data transmission period, the MIPI should forward all image data, thus resulting in large power consumption. In addition, the display panel 104 should be refreshed no matter whether the image content changes; that is, the display driver circuit 102 transmits the image data and corresponding control signals to all the active area of the display panel 104, so that all of the data lines and scan lines on the display panel 104 have a large amount of voltage switching, which is accompanied by frequent charging and discharging and thus generates a great amount of power consumption.

In order to save the power consumption, the host device 100 may only transmit the image data that need to be updated to the display driver circuit 102. The display driver circuit 102 only refreshes partial zones on the display panel 104 where the images need to be updated according to the received image data and the corresponding information of image position. In an embodiment, in the image frame N, the host device 100 first notifies the display driver circuit 102 of the range where the image data need to be updated. The host device 100 only transmits the updated image data in the image frame (N+1), and the display driver circuit 102 will only update the image data in this part.

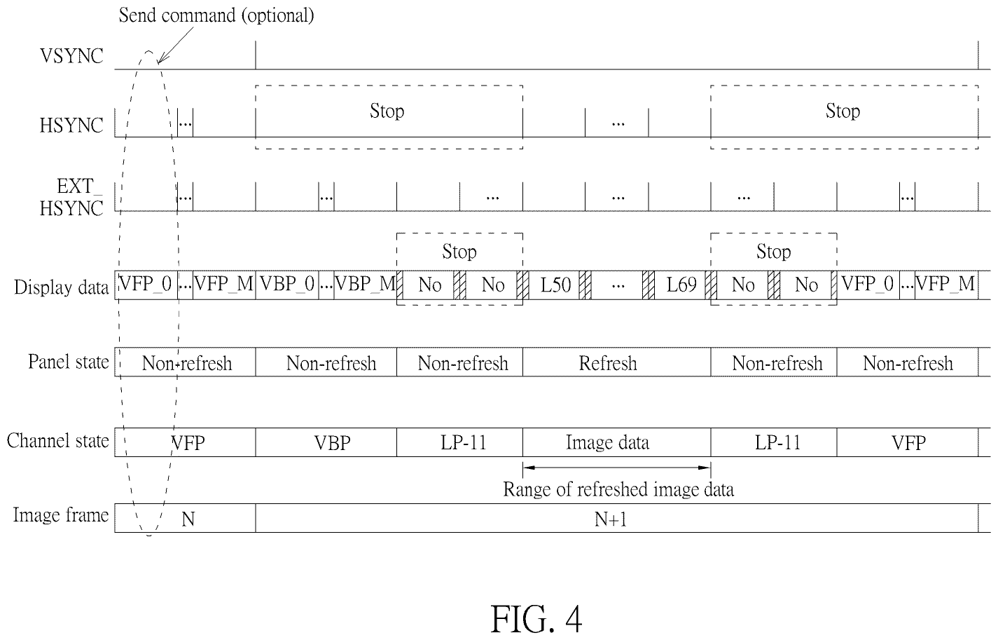

FIG. 4 is a timing diagram of a transmission interface through which the host device 100 transmits partial image data to the display driver circuit 102 to allow the display panel 104 to perform image refresh according to an embodiment of the present invention. Similar to the example shown in FIG. 3, the host device 100 may transmit at least one synchronization signal to the display driver circuit 102, including the vertical synchronization signal VSYNC and the horizontal synchronization signal HSYNC. The display driver circuit 102 may also receive the external horizontal synchronization signal EXT_HSYNC from an external device. The functions and operations of these synchronization signals are identical to those shown in FIG. 3, and will not be narrated herein.

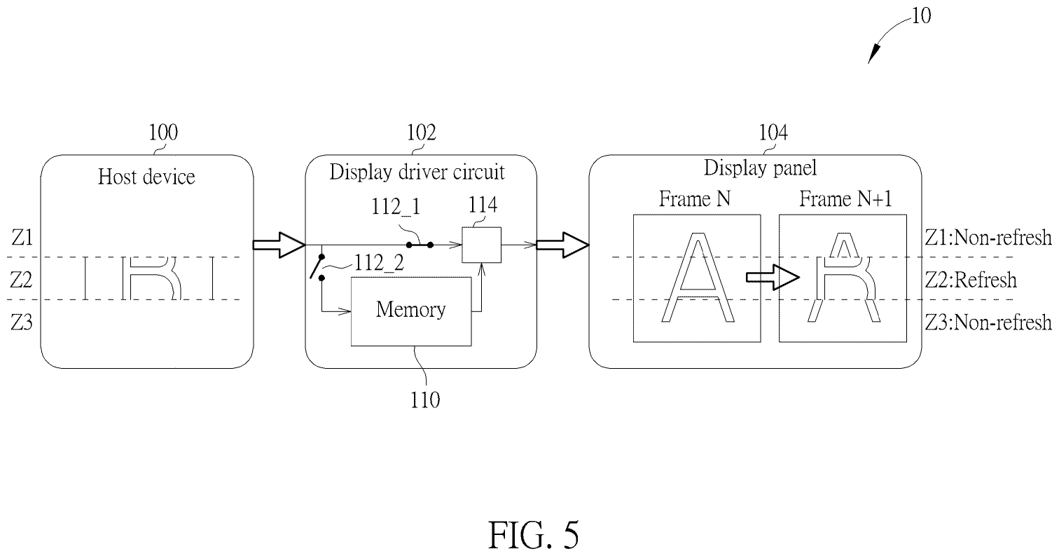

Similarly, assuming that there are 128 rows of pixels (i.e., 128 line data L0-L127) in an image frame of the display panel 104, in this embodiment, only the 51^{th} row to the 70^{th} row need to be refreshed. In such a situation, the host device 100 only transmits the corresponding line data L50-L69 to the display driver circuit 102. Correspondingly, the display driver circuit 102 controls the display panel 104 to refresh only the pixel rows corresponding to the line data L50-L69, and not refresh other pixel rows. Further referring to FIG. 5 along with FIG. 4, the display panel 104 is refreshed in the zone Z2 only, while the zones Z1 and Z3 are not refreshed since the images in these zones do not change.

For example, the host device 100 may write the information or command indicating the range of updated images into a specific buffer of the display driver circuit 102 in the image frame N. This specific buffer may store the information about the start of updated line data and the end of updated line data. Subsequently, in the image frame (N+1), the host device 100 may still transmit the image data to the display driver circuit 102 with the predetermined timing, but only the time period corresponding to the line data L50-L69 has data transmitted. In the time period of other line data, the host device 100 may only transmit the horizontal synchronization signal HSYNC to the display driver circuit 102, or may enter a low power mode. At this time, the display driver circuit 102 only refreshes the image data of the data lines (or called source lines) on the line L50-L69, and the data of the image frame N in other lines are kept. If the display panel 104 is an OLED panel, the data lines without updated image data may be maintained at specific voltages.

More specifically, as shown in FIG. 4, based on the timing determined by the vertical synchronization signal VSYNC and the horizontal synchronization signal HSYNC (or the external horizontal synchronization signal EXT_HSYNC), the line data L0-L127 in an image frame have corresponding transmission periods, wherein each line data L0-L127 corresponds to a transmission period determined by a pulse of the horizontal synchronization signal HSYNC. In other words, based on the control of the vertical synchronization signal VSYNC and the horizontal synchronization signal HSYNC (and/or the external horizontal synchronization signal EXT_HSYNC), a transmission time is reserved for each line data L0-L127 in the timing of MIPI. Among the line data L0-L127, as for those line data L50-L69 need to be refreshed, the host device 100 may transmit the line data L50-L69 to the display driver circuit 102 in their corresponding transmission periods. As for the other line data L0-L49 and L70-L127 not refreshed, the host device 100 may stop transmitting image data in their corresponding transmission periods, and the display driver circuit 102 may stop receiving the image data correspondingly.

As shown in FIG. 5, the display driver circuit 102 may be operated in the video mode of the MIPI, where the switch 112_1 is turned on and the switch 112_2 is turned off, so that the line data L50-L69 from the host device 100 may bypass the memory 110 and be directly transmitted to the image processing circuit 114. The image processing circuit 114 may process the line data L50-L69 to generate corresponding data voltages. The display driver circuit 102 then outputs these data voltages to the display panel 104, and also outputs corresponding control signals to the display panel 104 to turn on the pixels in the refresh area on the display panel 104, allowing the pixels to receive the corresponding data voltages. On the other hand, as for the other line data L0-L49 and L70-L127 not refreshed, the display driver circuit 102 may stop outputting any data voltage to the display panel 104, so as to reduce the power consumption generated from the charging and discharging operations on the data lines of the display panel 104. At this time, the display driver circuit 102 may also stop outputting the control signals to the display panel 104, or maintain the control signals at a specific voltage level, allowing the corresponding pixels to keep off.

In an embodiment, during the period where the host device 100 stops transmitting the image data to the display driver circuit 102, the MIPI may be set to a power saving state. The power saving state may be implemented in various manners. In one power saving state, the MIPI will not output image data in the data transmission period corresponding to the line data not refreshed, to stop the data transmission. At this time, the host device 100 only transmits the packets of the vertical synchronization signal VSYNC and the horizontal synchronization signal HSYNC to the display driver circuit 102 through the MIPI. Correspondingly, the display driver circuit 102 may determine the timing of data transmission according to the packets of the horizontal synchronization signal HSYNC such as the horizontal synchronization start (HSS) signal in the packets.

In another power saving state, in order to further reduce power consumption, the host device 100 may also stop outputting the horizontal synchronization signal HSYNC to the display driver circuit 102 in the period where transmission of the image data to the display driver circuit 102 is stopped. At this time, the voltage levels on the transmission channels of the MIPI will not be switched, thereby stopping the signal/data transmission. For example, as shown in FIG. 4, in the transmission periods originally reserved for the line data L0-L49 and L70-L127, transmissions of the image data and the horizontal synchronization signal HSYNC are both stopped, and thus the transmission channels of the MIPI may be set to LP-11, which is a channel state in the low power mode of the MIPI. At this time, the differential channels of the transmission channels are all kept at a high voltage level without switching, so as to reduce the power consumption of MIPI. Note that since the host device 100 stops outputting the horizontal synchronization signal HSYNC, the display driver circuit 102 should receive the external horizontal synchronization signal EXT_HSYNC (through an interface other than the MIPI) from an external device at this time, and use the external horizontal synchronization signal EXT_HSYNC to perform timing control for each row of image data; that is, to determine the transmission period of each row of image data.

In an embodiment, before transmitting partial display data of an image frame, the host device 100 may first output a command to the display driver circuit 102 to indicate the ranges of the image data to be refreshed and the image data not refreshed (e.g., the coordinates of the refreshed zones or blocks). For example, as shown in FIG. 4, as for the display data in the image frame (N+1), the host device 100 may send the command in a vertical front porch (e.g., VFP_0) before the pulse of the vertical synchronization signal VSYNC corresponding to the image frame (N+1). Alternatively, the host device 100 may send the command in a vertical back porch before the data transmission period, or may provide the information about the range of the image data to be refreshed to the display driver circuit 102 in an earlier time point. And alternatively, the host device 100 may send the command associated with the range of the image data to be refreshed to the display driver circuit 102 through another transmission interface.

As for the display driver circuit 102, when receiving the command from the host device 100, it may determine the range of refreshed image data and the range of non-refreshed image data according to the command, and control the display panel 104 to perform refreshing accordingly. Based on the timing information provided by the horizontal synchronization signal HSYNC (and/or the external horizontal synchronization signal EXT_HSYNC), the display driver circuit 102 will know the transmission period corresponding to each row of image data, and receive the image data in the transmission period corresponding to the refreshed range.

Note that the above operation of the host device 100 transmitting the command associated with the range of the image data to be refreshed is optional. In another embodiment, the host device 100 may not notify the display driver circuit 102 of the range of the image data that need to be updated or refreshed. In the data lines where the images are not updated, the host device 100 only transmits the horizontal synchronization signal HSYNC or directly enters a low power mode (e.g., LP-11). At this time, the display driver circuit 102 does not obtain the range of the refreshed image data from the host device 100; instead, the display driver circuit 102 determines the ranges of the refreshed image data and non-refreshed image data by itself according to the signal/data transmission state on the transmission interface. In the transmission period corresponding to each row of image data, the display driver circuit 102 may determine whether there are high-speed switching signals on the data transmission channels of the MIPI, or whether the channels are in the power saving state, thereby determining the range of the refreshed image data. For example, according to the packets of the horizontal synchronization signal HSYNC (and/or the timing information provided by the external horizontal synchronization signal EXT_HSYNC), the display driver circuit 102 may count the received HSYNC/EXT_HSYNC pulses. In addition, the display driver circuit 102 knows the number of HSYNC/EXT_HSYNC pulses contained in the vertical back porch, and the information along with pulse counting result are used to determine the start time of the data transmission period, and also determine the transmission time corresponding to subsequent rows of image data. Therefore, if there is no high-speed signal received on the data transmission channel after the data transmission period starts, the display driver circuit 102 may determine that the corresponding image data are not refreshed. Afterwards, if an image data is received in a specific transmission period, the display driver circuit 102 may determine that the refresh of image data starts at this position.

As a result, the display driver circuit 102 only needs to refresh the image data on the data lines (or called source lines) for the data lines to be updated, while other data lines are kept with the data of the previous frame. If the display panel 104 is an OLED panel, the data lines without updated image data may be maintained at specific voltages.

Also note that in the embodiment of FIG. 5, the switch 112_1 is turned on and the switch 112_2 is turned off, so that the line data L50-L69 bypass the memory 110, and may be directly processed by the image processing circuit 114 and immediately output to the display panel 104. In another embodiment, the switch 112_2 may be turned on and the switch 112_1 may be turned off, so that the image data from the host device 100 are transmitted to the memory 110 to be stored, and then read out from the memory 110 and converted into the corresponding data voltages to be output to the display panel 104 when the refresh is performed. As long as the display driver circuit 102 may receive a synchronization signal to determine the transmission timing of display data, and receive partial image data in a frame from the host device 100 to perform partial refresh, the related implementations should belong to the scope of the present invention.

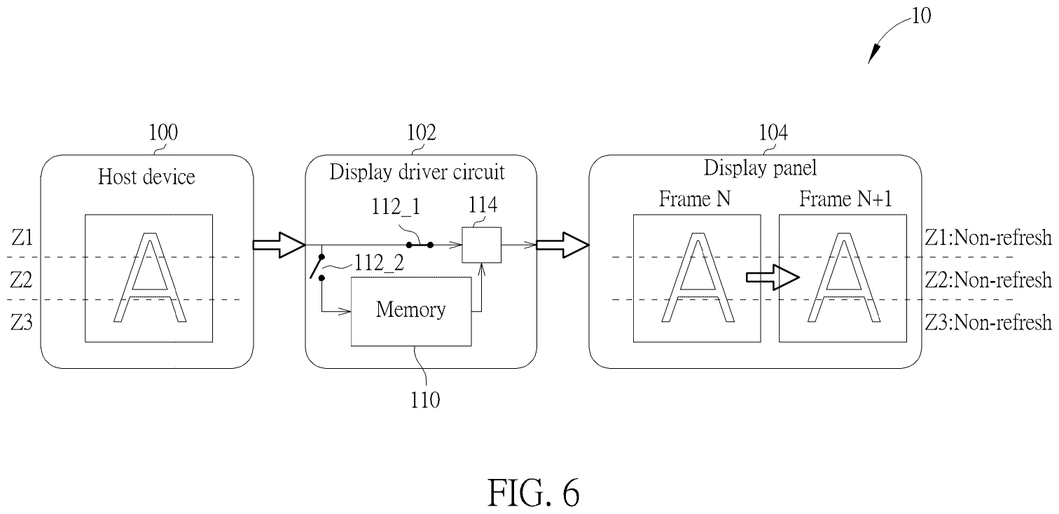

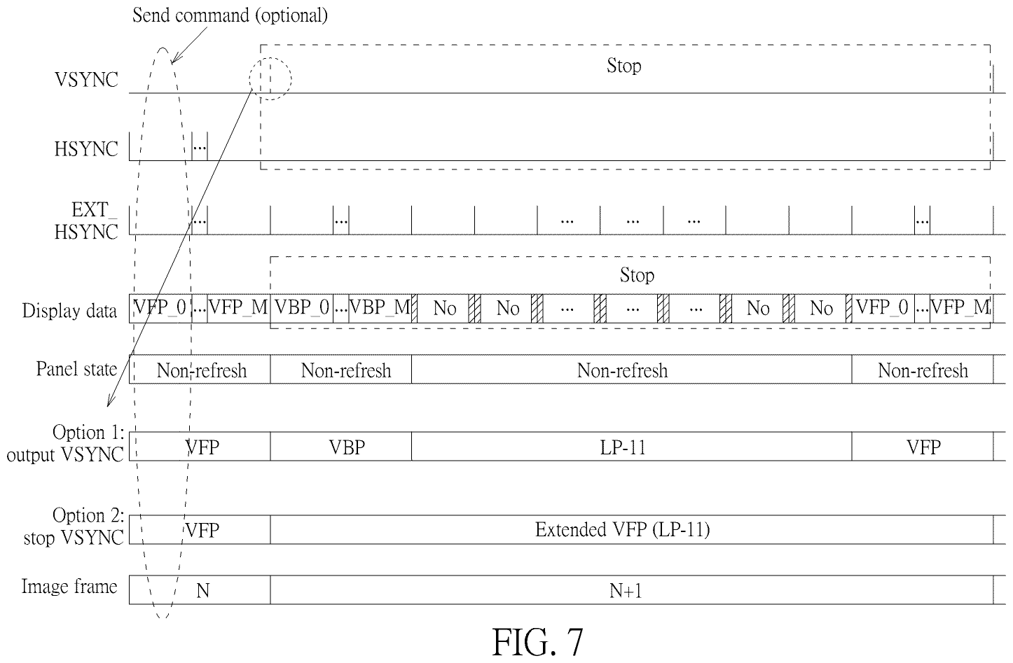

FIG. 6 illustrates the data transmission and refreshing method in the display system 10 when the image does not change according to an embodiment of the present invention. FIG. 7 is a timing diagram of signals and data transmitted between the host device 100 and the display driver circuit 102 based on the data transmission method of FIG. 6. In this embodiment, the host device 100 may determine whether the image data of each image frame is exactly identical to the image data of its previous image frame. When determining that the image data of the image frame (N+1) is exactly identical to those of the previous image frame N, the host device 100 may stop all the image data transmission in the frame period of the image frame (N+1). Correspondingly, on the display panel 104, no refresh is performed in all zones in the image frame (N+1). In other words, the images of the image frame (N+1) and the images of the image frame N displayed on the display panel 104 are exactly the same; hence, the display driver circuit 102 does not output any data voltages to the display panel 104 in the frame period of the image frame (N+1).

Similarly, in order to further reduce power consumption, the host device 100 may optionally stop outputting the horizontal synchronization signal HSYNC to the display driver circuit 102. Instead, the display driver circuit 102 receives the external horizontal synchronization signal EXT_HSYNC for timing control. As shown in FIG. 7, in an embodiment (option 1), the host device 100 may still send the vertical synchronization signal VSYNC to the display driver circuit 102 to determine the frame period of the image frame (N+1), and control the transmission channels to enter a power saving state (such as LP-11) in the frame period of the image frame (N+1). In detail, the transmission channels are in the power saving state during the vertical back porch VBP, the data transmission period and the vertical front porch VFP. In another embodiment (option 2), in order to achieve ultimate power saving, the host device 100 may also stop outputting the vertical synchronization signal VSYNC to the display driver circuit 102. In such a situation, the frame period of the image frame (N+1) may be regarded as an extended vertical front porch VFP of the previous frame N.

As shown in FIG. 7, in this embodiment, the host device 100 may also optionally send a command indicating that the transmissions of all image data in the image frame (N+1) are stopped to the display driver circuit 102. Alternatively, the display driver circuit 102 may determine whether to stop receiving the image data by itself by monitoring the state of the transmission interface.

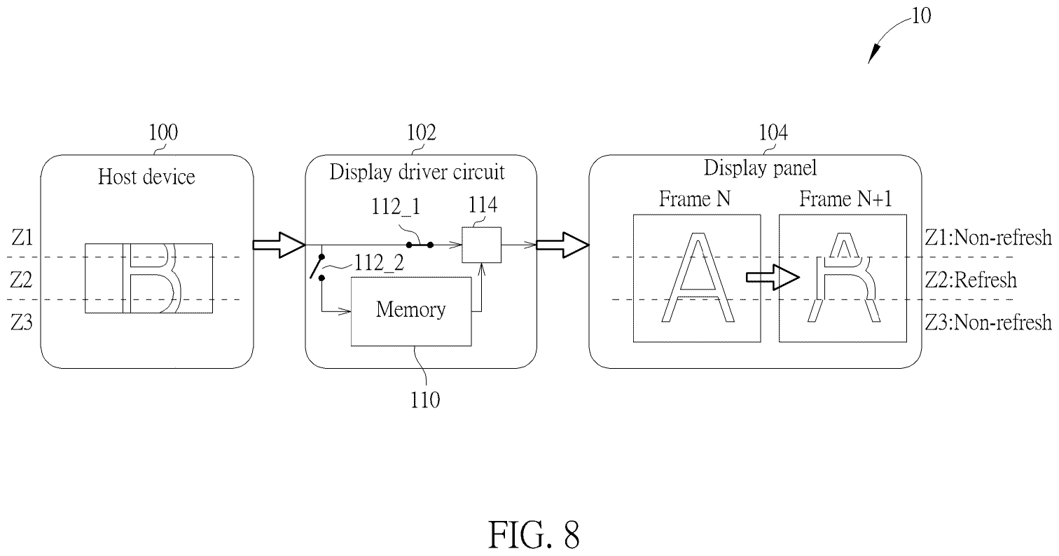

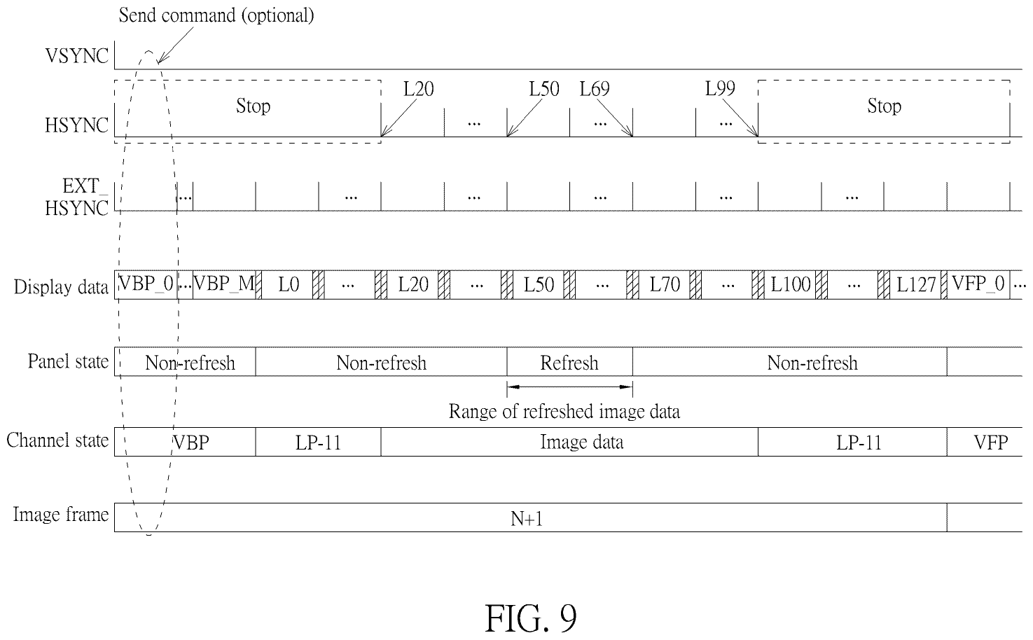

FIG. 8 illustrates the data transmission and refreshing method in the display system 10 according to another embodiment of the present invention. FIG. 9 is a timing diagram of signals and data transmitted between the host device 100 and the display driver circuit 102 based on the data transmission method of FIG. 8. In this embodiment, among the zones Z1-Z3 of the display panel 104, only the zone Z2 needs to be refreshed while the zones Z1 and Z3 are not refreshed. Assuming that the pixel rows of the zone Z2 correspond to the range of the line data L50-L69, the host device 100 may transmit a range of line data (e.g., L20-L99) slightly greater than the refreshed line data range to the display driver circuit 102, allowing the display driver circuit 102 to perform necessary image processing. As mentioned above, before the display panel 104 is refreshed, the display driver circuit 102 is requested to perform various image processing on the image data (e.g., through the image processing circuit 114) to enhance the visual effect. During the image processing process, the processing may refer to the raw image data within a larger range. Even if the panel zone corresponding to these additional image data is not refreshed, the host device 100 still needs to transmit these image data to the display driver circuit 102, so as to optimize the image processing effect.

As shown in FIG. 8, although only the pixel rows in the zone Z2 need to be refreshed, the host device 100 still transmits several image data in the zones Z1 and/or Z3, such as those image data near the zone Z2. In such a situation, the image processing circuit 114 in the display driver circuit 102 may perform image processing on the image data in the zone Z2 by referring to these additionally received image data.

In an embodiment, based on the image data range that needs to be referred for image processing, the display driver circuit 102 may first send related information to the host device 100. Therefore, according to the request of the display driver circuit 102, the host device 100 may transmit the corresponding additional line data in the data transmission period, and the range of the line data should not be limited to those described in this disclosure.

In addition, as for those image data not refreshed in the zones Z1 and Z3, their data content is usually the same as the image data in a previous image frame, which may have been stored in the memory 110 before the previous image frame is displayed. Therefore, in an embodiment, if the image data in the refreshed zone Z2 need to undergo image processing, the display driver circuit 102 may also obtain several image data of the zones Z1 and/or Z3 from the memory 110 as a reference, such as those image data near the zone Z2.

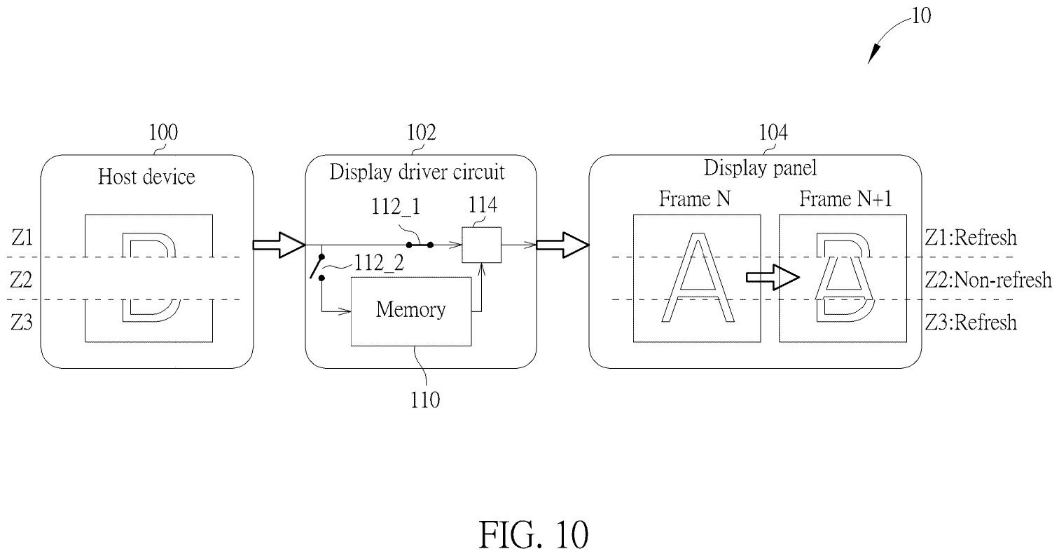

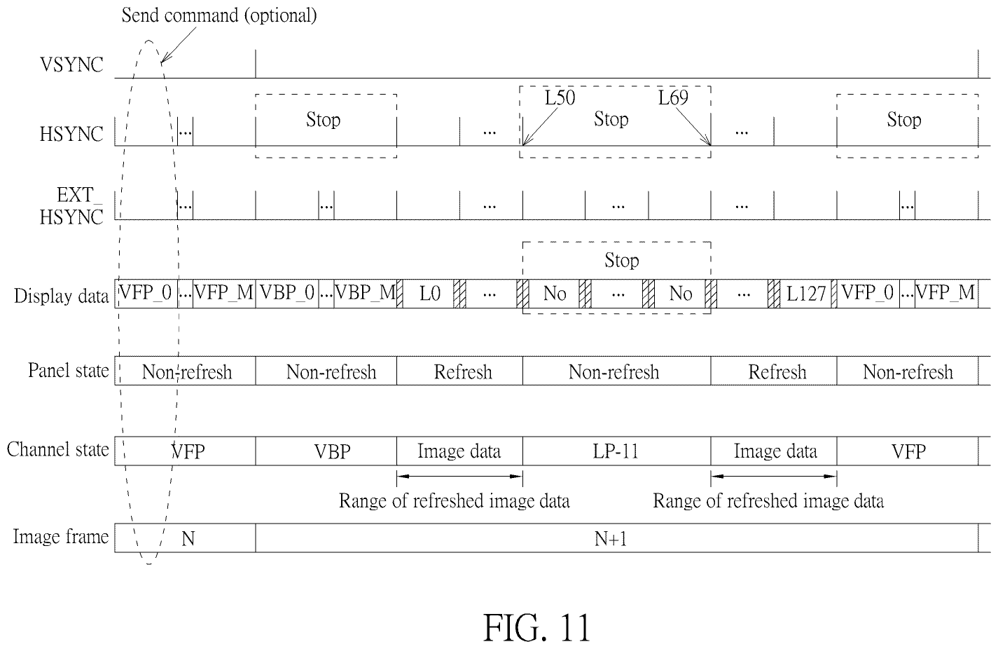

Note that in the above embodiment, the display panel 104 includes only one refreshed zone. But in other embodiments, the refreshed zone(s) on the display panel may be set in any manner based on the display data variations, and may be located in any position on the panel. Also, it is not limited that a frame of image includes only one refreshed zone. FIG. 10 illustrates the data transmission and refreshing method in the display system 10 according to a further embodiment of the present invention. FIG. 11 is a timing diagram of the signals and data transmitted between the host device 100 and the display driver circuit 102 based on the data transmission method of FIG. 10. In this embodiment, among the zones Z1-Z3 of the display panel 104, the zones Z1 and Z3 are refreshed and the zone Z2 is not refreshed. Correspondingly, on the MIPI connected between the host device 100 and the display driver circuit 102, the transmitted line data are L0-L49 (which correspond to the zone Z1) and L70-L127 (which correspond to the zone Z3). In the transmission period for the line data L50-L69 therebetween, the transmission of the image data is stopped and the interface enters the power saving state. The power saving method is similar to that described in the above embodiment, and will not be narrated herein.

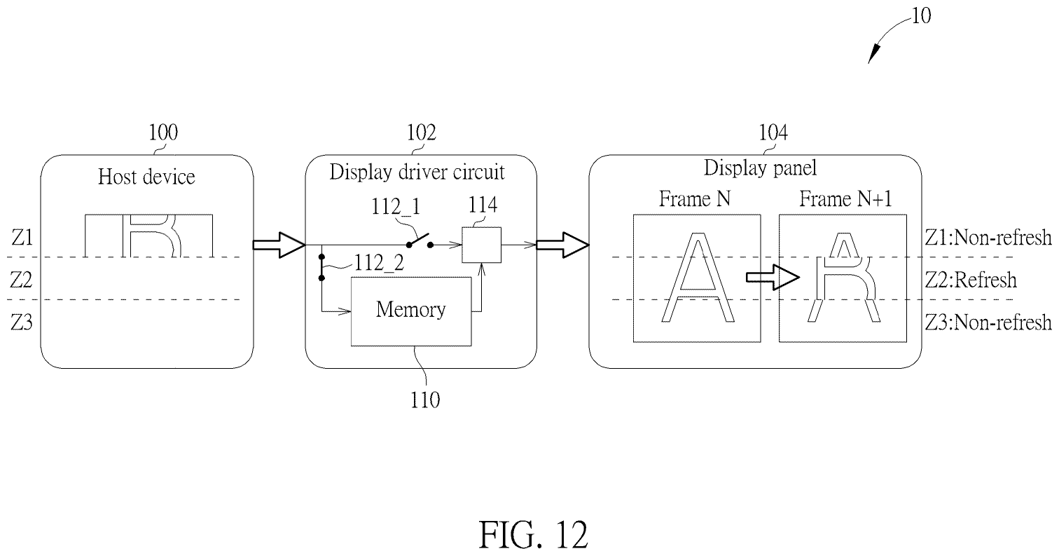

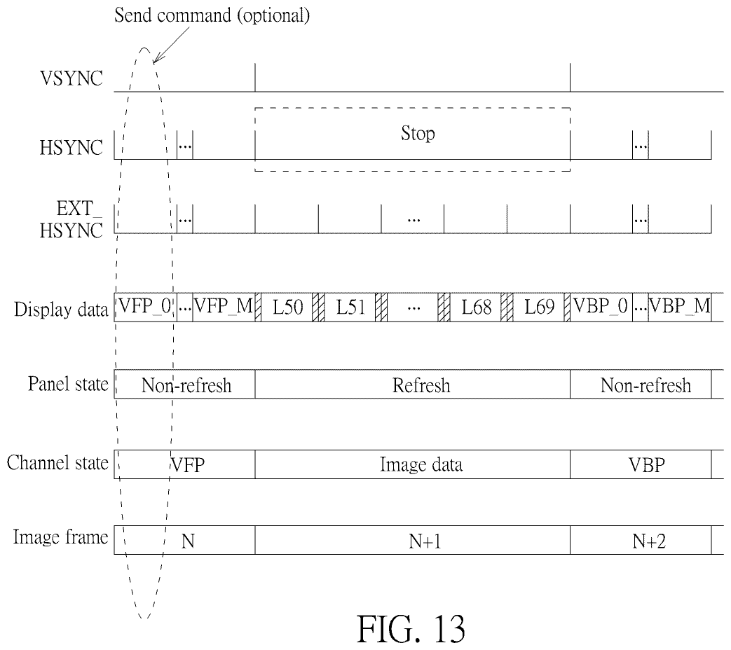

FIG. 12 illustrates the data transmission and refreshing method in the display system 10 according to an additional embodiment of the present invention. FIG. 13 is a timing diagram of the signals and data transmitted between the host device 100 and the display driver circuit 102 based on the data transmission method of FIG. 12. In this embodiment, the zone Z2 is refreshed and the zones Z1 and Z3 are not refreshed. In order to save the transmission time of the display data, the transmission periods corresponding to non-refresh image data may be omitted. In detail, as shown in FIG. 13, in the frame period of the image frame (N+1), the transmission periods for the non-refreshed line data L0-L49 and L70-L127 are omitted, and their vertical back porch VBP and vertical front porch VFP are also omitted. In such a situation, the line data L50-L69 may be transmitted earlier, thereby shortening the frame period and increasing the data transmission efficiency.

Similarly, in order to further reduce power consumption, the host device 100 may stop outputting the horizontal synchronization signal HSYNC to the display driver circuit 102. Instead, the display driver circuit 102 receives the external horizontal synchronization signal EXT_HSYNC for timing control. In addition, the host device 100 may optionally send a related command to the display driver circuit 102 before the frame period of the image frame (N+1), to indicate the omission of the transmission time. Note that in this embodiment, since the display driver circuit 102 receives the line data L50-L69 earlier, the line data L50-L69 may be written into the memory 110, and then read out from the memory 110 when the panel needs to be refreshed. In such a situation, the switch 112_2 should be turned on and the switch 112_1 should be turned off, as shown in FIG. 12.

In the above embodiment, the display panel 104 is partitioned along the Y-direction (i.e., vertical direction) to determine whether each zone is refreshed or not, i.e., to determine whether to perform refresh by taking a pixel row as a unit. However, in other embodiments, the partition may be performed along the X-direction (i.e., horizontal direction); that is, whether to perform refresh is determined by taking one or more pixels in a row as a unit, so as to realize more flexible partial refresh applications. The host device 100 may transmit the refreshing image data to the display driver circuit 102 in the corresponding transmission time according to the partitioning method of X-direction combined with Y-direction.

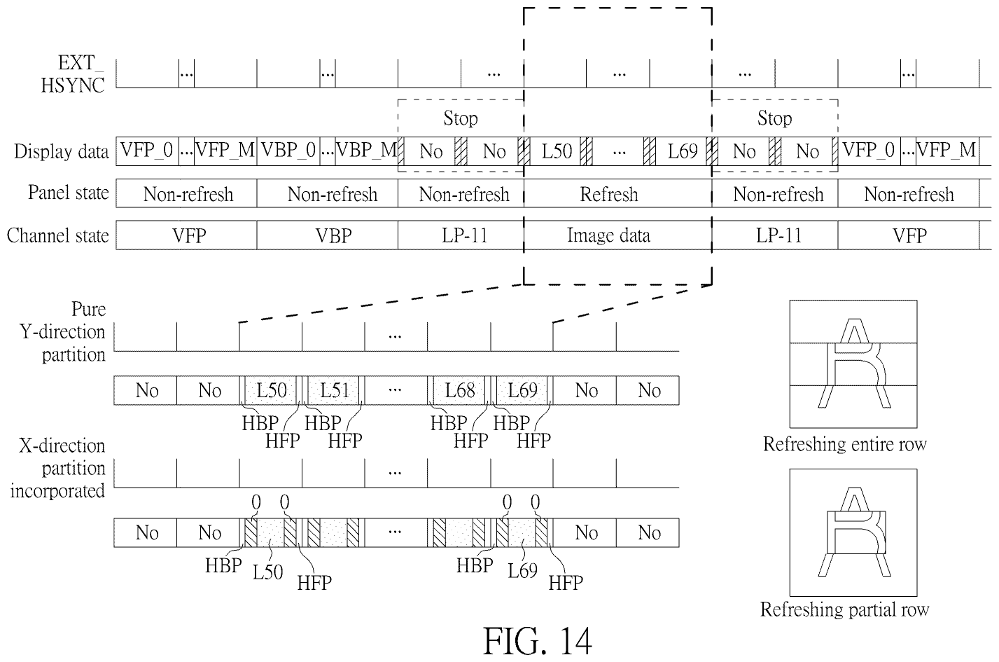

FIG. 14 illustrates a data transmission method incorporating the refresh of X-direction partition according to an embodiment of the present invention. As shown in FIG. 14, the image data of the refreshed zone are in the 51^{st} row to the 70^{th} row, and the timing diagram in these rows is zoomed out to facilitate the illustrations. In detail, a pulse of the horizontal synchronization signal HSYNC (or the external horizontal synchronization signal EXT_HSYNC) may be used to determine a line time, and each line time is used for transmitting one line data. Each line time may include a horizontal back porch HBP, a data transmission period and a horizontal front porch HFP.

If the pure Y-direction partition is applied, the host device 100 may transmit all of the line data L50-L69 in the refreshed zone to the display driver circuit 102, and the display panel 104 may correspondingly refresh the entire rows of pixels. If the X-direction partition is incorporated, the host device 100 only needs to transmit the image data in the refreshed zone, i.e., partial image data that need to be refreshed among the line data L50-L69. The display driver circuit 102 may control the display panel 104 to update the images in partial zones by controlling the data lines (i.e., source lines) and the scan lines (i.e., gate lines) to be turned on or off. In such a situation, in the transmission periods corresponding to other non-refreshed zones, the transmission interface may be controlled to enter the power saving state. In an embodiment, if the MIPI is applied to perform data transmission between the host device 100 and the display driver circuit 102, during the periods where no image data is transmitted, the transmission channels may be controlled to always output the data 0 or output a fixed data, thereby reducing the signal switching on the transmission channels. As a result, the image data are transmitted only in the transmission periods corresponding to the refreshed zones (i.e., partial transmission period in a row), so that the power consumption of the transmission interface may be minimized.

Note that in the above embodiments, as for those transmission periods without any image data transmitted on the transmission interface, the power saving state of LP-11 is applied. However, the embodiment of FIG. 14 applies the method of outputting the data 0 (or outputting a specific fixed data) to reduce power consumption. This is because a mode transition process is necessary when entering the power saving state of LP-11 according to the MIPI specification, and thus much time is consumed. In the embodiment of FIG. 14, in a line time used for receiving a row of pixels, only the image data of partial pixels stop transmitted, where the stop time may be extremely short, which is not enough to allow the transmission interface to enter the power saving state of LP-11. In such a situation, the method of outputting a fixed data value may be applied to reduce the signal switching. In another embodiment, if the time of stopping transmitting image data is long enough, LP-11 or any other suitable power saving methods may be feasible. As for the periods of the horizontal/vertical back porch or horizontal/vertical front porch, the host device 100 may optionally output a fixed data 0 or set the interface to enter LP-11 according to its length, or alternatively use any other suitable power saving method. The related implementations should all belong to the scope of the present invention.

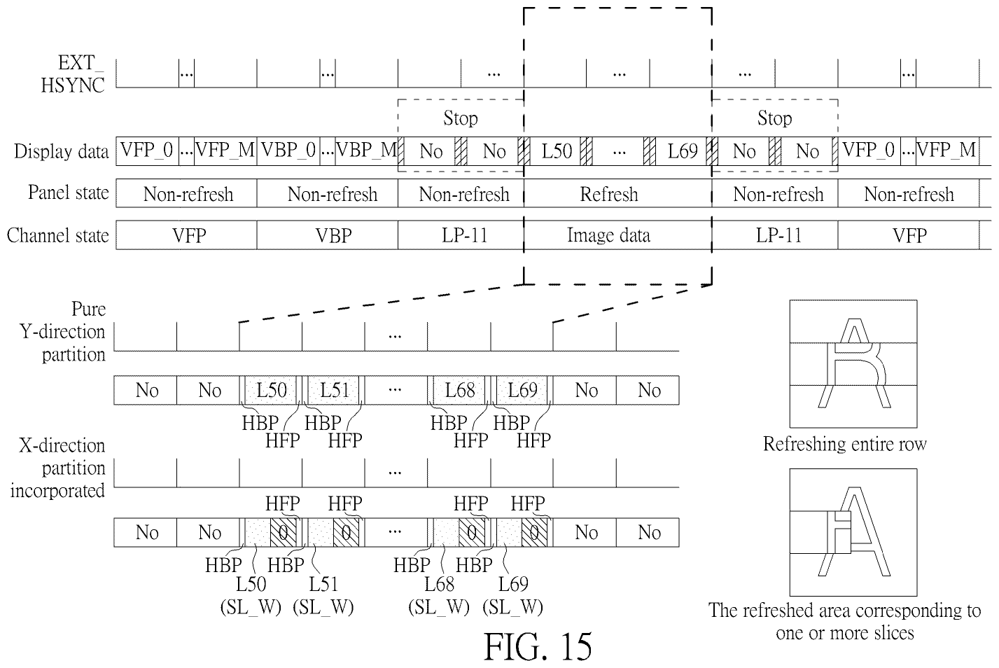

FIG. 15 illustrates another data transmission method incorporating the refresh of X-direction partition according to an embodiment of the present invention. The difference between the embodiment of FIG. 15 and the embodiment of FIG. 14 is that, the embodiment of FIG. 15 further uses data compression to perform panel refresh and corresponding data transmissions. Due to the limitation of the transmission bandwidth of MIPI, in order to support the great data amount of a high-resolution display panel currently in the market, t the display data should be compressed before being transmitted by the host device 100. The display driver circuit 102 thereby performs decompression on the received display data to restore the raw display data, and then performs subsequent operations such as image processing and/or sending to the display panel 104. The compression and decompression may reduce the data amount forwarded through MIPI; hence, the bandwidth requirements of MIPI may be satisfied, and the power consumption required during the data transmission process may also be reduced.

Currently, the compression of display data mostly uses the display stream compression (DSC) technology, where the compression architecture is that two decoders (or referred to as decompressors) are deployed in the display driver circuit 102. One of the decoders is responsible for the image data in the left half of the display panel 104, and the other decoder is responsible for processing the image data in the right half of the display panel 104. For example, assuming that there are 128 columns of pixels on the display panel 104, a decoder is responsible for processing the 1^{st} column to the 64^{th} column of pixels, and the other decoder is responsible for processing the 65^{th} column to the 128^{th} column of pixels. In such a situation, the compression performed by the host device 100 should follow the same rule; that is, performing compression by taking the pixels in every 64 columns and N rows as a unit, where N may be any positive integer within the total row number. In the DSC specification, a compression unit is called a slice, and the size of a compression unit is determined from the slice width and the slice height. In this embodiment, the slice width is 64 and the slice height is N.

Under the above compression scheme, the minimum unit of the host device 100 transmitting display data is one slice, of which the width is equal to one half of the total column number of the display panel 104. Even if the refresh area with changed images is smaller than the slice size, the host device 100 should still perform compression on all image data of the slice and then transmit the slice to the display driver circuit 102, and thus the display driver circuit 102 is able to correspondingly perform decompression to restore the raw data. In other words, a slice transmitted by the host device 100 may include several refreshed image data and several non-refreshed image data. The encoders (or referred to as compressors) included in the host device 100 may combine these image data and perform compression, and then the compressed data are transmitted to the display driver circuit 102 through the MIPI. Correspondingly, the decoders in the display driver circuit 102 may perform decompression on the compressed data (i.e., the slice) received from the host device 100, to restore the refreshed image data and the non-refreshed image data.

As shown in FIG. 15, when the X-direction partition is incorporated, as for the line data L50-L69 having the refreshed zone, the image data forwarded through the transmission interface are those contained in the slice width SL W, which is the left half of the panel in this embodiment. Note that in the embodiment shown in FIG. 15, the transmitted image data are partial image data among the line data L50-L69, but in another embodiment, if the slice height exceeds the range of the line data L50-L69, the image data to be compressed and forwarded through the transmission interface should be extended to upper rows and/or lower rows based on the range of the slice height.

Note that the present invention aims at providing a data transmission method, which may be used for a transmission interface between the display driver circuit and the host device to realize partial refresh of display data. Those skilled in the art may make modifications and alterations accordingly. For example, in the embodiments of the present invention, the host device may stop transmitting the image data in the transmission period corresponding to the image data in the non-refreshed zone to achieve the purpose of power saving. Stopping transmission may be achieved in any manner, such as using the channel state LP-11 of the MIPI to stop data signal switching, or outputting a specific fixed data, or applying the power saving mode of any transmission interface to reduce power consumption. The power saving implementation should not serve to limit the scope of the present invention. In addition, in the above embodiments, the display driver circuit 102 is deployed with the memory 110 as a frame buffer; hence, the display driver circuit 102 may not only support the video mode of MIPI based on the timing determined by the vertical/horizontal synchronization signals, but also support the applications of the command mode or hybrid mode. Through the control of switches, the display driver circuit may be flexibly switched between various operation modes. In another embodiment, the display driver circuit may support the video mode only. In such a situation, when the panel needs to be refreshed, the display driver circuit may receive the partial image data that need to be refreshed from the host device without including any frame buffer. This may further save the circuit area and reduce the power consumption required by the read/write operations of the memory.

The abovementioned data transmission method related to the display driver circuit may be summarized into a data transmission process 160, as shown in FIG. 16. The data transmission process 160 may be implemented in a display driver circuit of a display system, such as the display driver circuit 102 shown in FIG. 1. The display driver circuit may perform data transmission with a host device through a transmission interface, in order to perform partial refresh on the display panel. As shown in FIG. 16, the data transmission process 160 includes the following steps:
Step 1602: Receive at least one first synchronization signal, which is used for determining a frame period for a plurality of image data in an image frame.
Step 1604: As for a first image data to be refreshed among the plurality of image data, receive the first image data in a first transmission period corresponding to the first image data.
Step 1606: As for a second image data not refreshed among the plurality of image data, stop receiving the second image data in a second transmission period corresponding to the second image data.

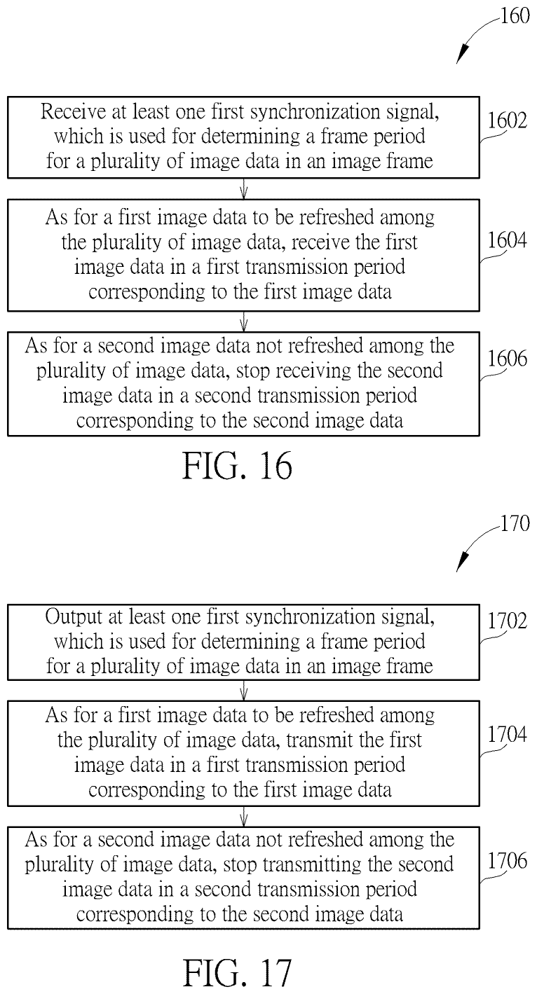

On the other hand, the data transmission method related to the host device may be summarized into another data transmission process 170, as shown in FIG. 17. The data transmission process 170 may be implemented in a host device of a display system, such as the host device 100 shown in FIG. 1. The host device may perform data transmission with a display driver circuit through a transmission interface, in order to perform partial refresh on the display panel. As shown in FIG. 17, the data transmission process 170 includes the following steps:
Step 1702: Output at least one first synchronization signal, which is used for determining a frame period for a plurality of image data in an image frame.
Step 1704: As for a first image data to be refreshed among the plurality of image data, transmit the first image data in a first transmission period corresponding to the first image data.
Step 1706: As for a second image data not refreshed among the plurality of image data, stop transmitting the second image data in a second transmission period corresponding to the second image data.

The detailed operations and alterations associated with the data transmission processes 160 and 170 are illustrated in the above paragraphs, and will not be narrated herein.

To sum up, the present invention provides a data transmission method used for a transmission interface between the display driver circuit and the host device in a display system, to realize partial refresh of display data. In the embodiments of the present invention, the display driver circuit may receive the vertical/horizontal synchronization signals from the host device, and/or receive the external horizontal synchronization signal from an external device, to control the timing of image data transmission according to the synchronization signals; that is, to set up a transmission period for each line of image data. As for the image data that need to be refreshed, the host device may transmit the image data to the display driver circuit in the corresponding transmission period, and the display driver circuit may receive the image data and accordingly drive the display panel to perform refresh. As for the image data not refreshed, the host device may stop transmitting the image data to the display driver circuit in the corresponding transmission period, and the display driver circuit may stop receiving the image data. In such a situation, the display panel is not refreshed. Through the above data transmission method, only partial image data to be refreshed are forwarded between the host device and the display driver circuit, so that only parts of areas in an image frame on the display panel is refreshed, thereby reducing the power consumption on the transmission interface between the host device and the display driver circuit and the power consumption of the display panel. In an embodiment, the host device may determine the range of the refreshed zone according to the content of image data to be transmitted, and send a command carrying related information to the display driver circuit. Alternatively, the display driver circuit may determine the ranges of the refreshed image data and non-refreshed image data according to the data transmission state of the transmission interface, and control the display panel to perform partial refresh accordingly, thereby achieving the purpose of power saving.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data transmission method for a display driver circuit comprising:
receiving at least one first synchronization signal to determine a frame period for a plurality of image data in an image frame;
when a first image data to be refreshed among the plurality of image data, receiving the first image data in a first transmission period corresponding to the first image data; and
when a second image data not refreshed among the plurality of image data, stopping receiving the second image data in a second transmission period corresponding to the second image data.

2. The data transmission method of claim 1, wherein the frame period determined by the at least one first synchronization signal comprises a data transmission period, a front porch and a back porch, wherein the first transmission period and the second transmission period are within the data transmission period.

3. The data transmission method of claim 1, further comprising:
stopping receiving a first synchronization signal among the at least one first synchronization signal from a host device in the second transmission period; and
receiving a second synchronization signal from an external device, to use the second synchronization signal to determine the first transmission period and the second transmission period.

4. The data transmission method of claim 1, wherein the display driver circuit receives the first image data through a transmission interface, and the transmission interface is set to a power saving state in the second transmission period.

5. The data transmission method of claim 1, further comprising:
outputting a data voltage corresponding to the first image data to a display panel when the first image data is refreshed; and
stopping outputting any data voltage to the display panel when the second image data is not refreshed.

6. The data transmission method of claim 1, wherein the plurality of image data comprise a plurality of first image data and a plurality of second image data, and the data transmission method further comprises:
receiving a command from a host device before the frame period; and
determining a range of the plurality of first image data and the plurality of second image data according to the command.

7. The data transmission method of claim 1, wherein the display driver circuit is configured to receive the plurality of image data through a transmission interface, the plurality of image data comprising a plurality of first image data and a plurality of second image data, and the data transmission method further comprises:
determining a range of the plurality of first image data and the plurality of second image data according to a state of the transmission interface.

8. The data transmission method of claim 1, further comprising:
in addition to receiving the first image data in the first transmission period, receiving a third image data not refreshed among the plurality of image data.

9. The data transmission method of claim 8, further comprising:
performing an image processing on the first image data by referring to the third image data.

10. The data transmission method of claim 8, further comprising:
performing decompression on a slice comprising the first image data and the third image data.

11. A data transmission method for a host device comprising:
outputting at least one first synchronization signal to determine a frame period for a plurality of image data in a first image frame;
when a first image data to be refreshed among the plurality of image data, transmitting the first image data in a first transmission period corresponding to the first image data; and
when a second image data not refreshed among the plurality of image data, stopping transmitting the second image data in a second transmission period corresponding to the second image data.

12. The data transmission method of claim 11, wherein the frame period determined by the at least one first synchronization signal comprises a data transmission period, a front porch and a back porch, wherein the first transmission period and the second transmission period are within the data transmission period.

13. The data transmission method of claim 11, wherein the at least one first synchronization signal and the first image data are transmitted to a display driver circuit.

14. The data transmission method of claim 13, further comprising:
stopping transmitting a first synchronization signal among the at least one first synchronization signal to the display driver circuit in the second transmission period.

15. The data transmission method of claim 11, wherein the host device transmits the first image data through a transmission interface, and the transmission interface is set to a power saving state in the second transmission period.

16. The data transmission method of claim 11, further comprising:
stopping transmitting a plurality of image data of a second image frame after the first image frame in another frame period corresponding to the second image frame when the plurality of image data of the second image frame are determined to be identical to the plurality of image data of the first image frame.

17. The data transmission method of claim 16, further comprising:
stopping outputting the at least one first synchronization signal in the other frame period corresponding to the second image frame.

18. The data transmission method of claim 11, wherein the plurality of image data comprise a plurality of first image data and a plurality of second image data, and the data transmission method further comprises:
outputting a command to a display driver circuit before the frame period, to indicate a range of the plurality of first image data and the plurality of second image data.

19. The data transmission method of claim 11, further comprising:
in addition to transmitting the first image data in the first transmission period, transmitting a third image data not refreshed among the plurality of image data.

20. The data transmission method of claim 11, further comprising:
combining the first image data and the third image data to perform compression, and transmitting the first image data and the third image data after being compressed.
